(19) United States
(12) Patent Application Publication
(10) Pub. No.: US 2023/0204378 A1
(43) Pub. Date: Jun. 29, 2023

(54) DETECTING AND MONITORING DANGEROUS DRIVING CONDITIONS

(71) Applicant: HERE Global B.V., Eindhoven (NL)

(72) Inventor: James Adeyemi Fowe, Chicago, IL (US)

(21) Appl. No.: 17/562,143

(22) Filed: Dec. 27, 2021

(51) Int. Cl. G01C 21/00; G01S 19/13; G08G 1/01

(52) U.S. Cl. CPC G01C 21/3833; G01S 19/13; G08G 1/0112

(57) ABSTRACT

System and methods for using probes to detect and elicit dangerous driving conditions. Historical probe data is aggregated and analyzed to identify reoccurring dangerous driving conditions down to the lane level. The lane level locations with high recurring dangerous driving condition metrics are identified and analyzed by a mapping system. The mapping system uses machine learning and other techniques to investigate, validate, and verify the dangerous driving conditions to ascertain the cause and then categorize the dangerous driving condition.

### FIELD

The following disclosure relates to navigation devices or services.

### BACKGROUND

Dangerous driving conditions (DDC) exist in roadways and may affect vehicles and vehicle operators as the roadways are traveled. These conditions may be caused by, for example, poorly maintained roadway surfaces, dangerous configurations of curves or intersections, roadway obstructions, etc. These dangerous driving conditions may cause or result in events impacting specific vehicles on the roadway.

Notifying vehicles or operators of vehicles of dangerous driving conditions, or events caused by dangerous driving conditions, may be beneficial to mitigating the overall effects of such conditions on traffic flows and safety of a roadway system. Typical navigation applications and services are able to provide insight into the operation of a vehicle on the roadway by providing notifications regarding traffic incidents. For example, many services are able to provide traffic incident data to a user or device by providing a marker or feature that can be added to the map as a result of a traffic incident report. Similarly, navigation applications and services may be able to provide notifications for dangerous driving conditions by placing a marker or otherwise indicating a road segment where a reported dangerous driving condition exists. In an example, a user may report a pothole at a certain location using a non-emergency city application. A navigation application may access the city application to view the report and mark the location.

Charting, verifying, tracking, or otherwise identifying the dangerous driving conditions, or the dynamic events which dangerous driving conditions cause, may be difficult in large roadway systems often involving thousands of miles of roads. As in the above example, notification systems may rely on annotated but unverified reports from vehicles that describe the dangerous driving condition in detail. While these types of systems may be useful for many drivers, more intelligent systems are frequently expected and required by drivers or autonomous vehicles. Operators expect and demand both ideal and safe routes and accurate arrival times. The older systems of acquiring and publishing reports is not sufficient to provide these levels of service.

### SUMMARY

In an embodiment, a method is provided for detecting dangerous driving conditions. The method includes acquiring lane-level map matched probe data for a plurality of locations, identifying dangerous driving events in the lane-level map matched probe data on one or more lane locations, determining one or more reoccurring lane locations that exhibit reoccurring dangerous driving events, ascertaining a cause of the reoccurring dangerous driving events for each of the one or more reoccurring locations, and generating and storing an artifact for each of the one or more reoccurring locations that includes an ascertained dangerous driving condition type.

In an embodiment, a method is provided for providing real-time event warnings. The method includes acquiring real-time probe data for a location, identifying the location as experiencing a dangerous driving condition based on a dangerous driving condition artifact, determining that the dangerous driving condition is ongoing based on the real-time probe data, increasing a confidence metric of the dangerous driving condition artifact, and publishing a dangerous driving condition event warning when the confidence metric exceeds a predefined threshold.

In an embodiment, a system is provided for detecting dangerous driving conditions. The system includes one or more probe devices, a geographic database, and a mapping server. The one or more probe devices are configured to acquire probe data. The geographic database is configured to store probe data and artifact data related to dangerous driving conditions. The mapping server is configured to aggregate the probe data for locations and time periods, determine, based on probe data for a respective location and respective time period, that a dangerous driving condition exists for the respective location and respective time period, and generate and store artifact data for the dangerous driving condition.

### BRIEF DESCRIPTION OF THE DRAWINGS

Exemplary embodiments of the present invention are described herein with reference to the following drawings.

FIG. 1 depicts an example system for detecting dangerous driving conditions according to an embodiment.

FIG. 2 depicts an example workflow for detecting dangerous driving conditions according to an embodiment.

FIGS. 3A and 3B depicts an example of a dangerous driving condition.

FIG. 4 depicts an example of a dangerous driving condition artifact according to an embodiment.

FIG. 5 depicts an example workflow for training and applying a machine trained model for classification of dangerous driving conditions according to an embodiment.

FIG. 6 depicts an example server of the system of FIG. 1 according to an embodiment.

FIG. 7 depicts an example device of the system of FIG. 1 according to an embodiment.

FIG. 8 depicts an example workflow for generating a dangerous driving condition artifact according to an embodiment.

FIG. 9 depicts an example workflow for adjusting a confidence metric for a dangerous driving condition according to an embodiment.

FIG. 10 depicts an example region of a geographic database.

FIG. 11 depicts an example geographic database of FIG. 1.

FIG. 12 depicts an example structure of the geographic database.

FIG. 13 depicts an example autonomous vehicle according to an embodiment.

### DETAILED DESCRIPTION

Embodiments provide systems and methods for using probes to detect and elicit dangerous driving conditions (DDC). Historical probe data is aggregated and analyzed to identify reoccurring dangerous driving conditions down to the lane level. The lane level locations with high recurring dangerous driving condition metrics (such as reoccurring or repeated sudden breaking, jerks, sudden lane change, etc.) are identified and analyzed by a mapping system. The mapping system uses machine learning and other techniques to investigate, validate, and verify the dangerous driving conditions using cameras, sensors, and other sources of traffic information to ascertain the cause and then categorize the dangerous driving condition. After review and categorization, an artifact is generated and stored in a geographic database. Using the artifact, navigation systems may mark the location with the type of dangerous driving condition that includes event type, probability/confidence, and time it occurs. This artifact further informs real-time navigation applications and systems of the locations to monitor to confirm if the event is ongoing or re-occurring. A confidence value may be increased or decreased based on on-going monitoring.

Intelligent traffic systems perform analysis on probe reports and other data in order to provide safe and accurate routing solutions for the movement of people, goods, and vehicles. Accurate routing capabilities may be based on enterprise-grade maps and location data and can adapt routes to real-world circumstances in real-time. These intelligent traffic systems may provide accurate estimated time of arrivals (ETAs) that take into account real-time congestion and incidents. Embodiments provided herein build upon the intelligent traffic systems by detecting and monitoring locations with potential for dangerous driving conditions. Recurring dangerous driving conditions on the road may be present due to several factors. Embodiments are not only able to identify these locations but also to be able to detect in real-time if/when the cause of the dangerous driving condition is ongoing. Embodiments use metrics that indicate a driver or vehicle is experiencing a dangerous driving condition e.g., sudden breaking, jerking, sudden lane changes, swerving, etc. The road segments with the higher numbers of recurring dangerous driving condition events for various time epochs are identified and analyzed by the mapping system to identify the causes of this dangerous driving condition events. The mapping system categorizes the event for navigation impacts either routing or ETA or safety warnings.

The following embodiments relate to several technological fields including but not limited to navigation, traffic applications, and other location-based systems. The following embodiments achieve advantages in each of these technologies because an increase in the accuracy of the identification of dangerous conditions improves the effectiveness, efficiency, and speed of specific application in these technologies. In each of the technologies of navigation, traffic applications, and other location-based systems, improved identification of dangerous conditions improves the technical performance of the application. In addition, users of navigation, traffic applications, and other location-based systems are more willing to adopt these systems given the technological advances in dangerous conditions tracking and monitoring.

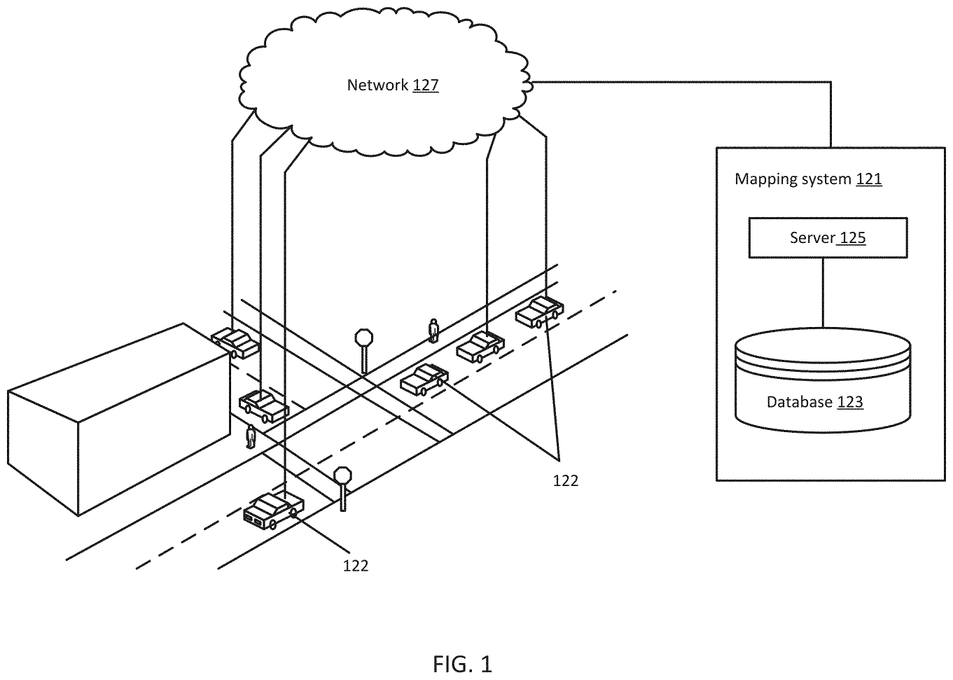

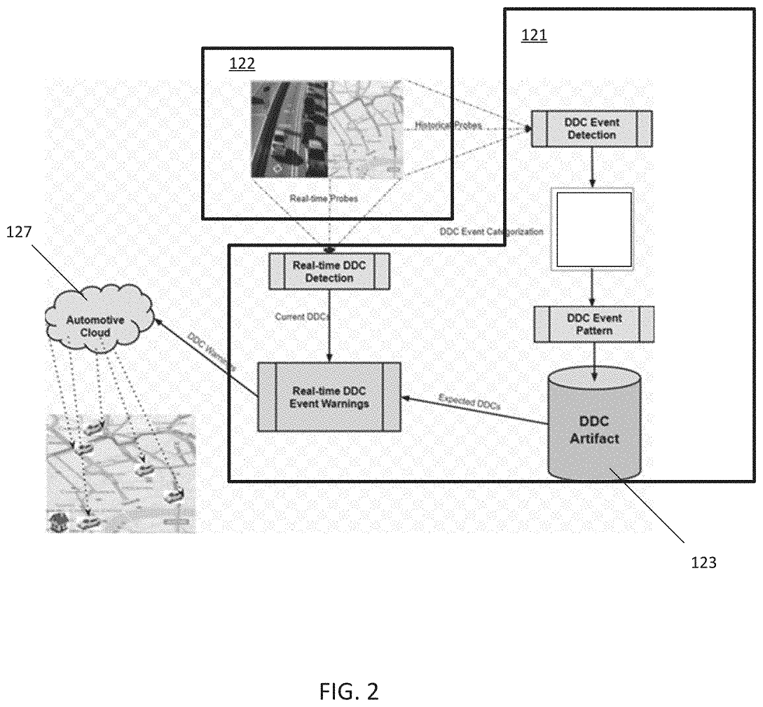

FIG. 1 depicts a system for detecting dangerous driving conditions. The system includes at least one or more devices 122, a network 127, and a mapping system 121. The mapping system 121 may include a database 123 (also referred to as a geographic database 123 or map database) and a server 125. Additional, different, or fewer components may be included. FIG. 2 depicts an example workflow for detecting dangerous driving conditions. In FIG. 2, one or more of the devices 122 are configured to detect dangerous driving condition metrics for conditions on lanes on the roadway. Dangerous driving condition metrics may include symptoms or indicators that a dangerous driving condition is present at a location (for example non-normal driving maneuvers or actions). The dangerous driving condition metrics are aggregated by the mapping system 121. Locations with high recurring dangerous driving condition metrics are identified and reviewed by the mapping system 121. The mapping system 121 investigates the locations using sensors, cameras, and other sources of traffic and mapping information to ascertain the cause and then categorize the dangerous driving condition and the cause. Artifacts for the reoccurring locations are stored in the geographic database. In real-time, one or more of the devices 122 communicate with the mapping system 121 to access the artifacts in order to provide navigation services or instructions. The devices 122 further are configured to collect data about the dangerous driving condition and locations in order to adjust a confidence value of the dangerous driving condition.

The one or more devices 122 may include probe devices 122, probe sensors, IoT (internet of things) devices 122, or other devices 122 such as personal navigation devices 122 or connected vehicles. The device 122 may be a mobile device or a tracking device that provides samples of data for the location of a person or vehicle. The devices 122 may include mobile phones running specialized applications that collect location data as the devices 122 are carried by persons or things traveling a roadway system. The one or more devices 122 may include traditionally dumb or non-networked physical devices and everyday objects that have been embedded with one or more sensors or data collection applications and are configured to communicate over a network 127 such as the internet. The devices 122 may be configured as data sources that are configured to acquire sensor data and/or roadway feature data. These devices 122 may be remotely monitored and controlled. The devices 122 may be part of an environment in which each device 122 communicates with other related devices in the environment to automate tasks. The devices 122 may communicate sensor data to users, businesses, and, for example, the mapping system 121.

The one or more devices 122 are configured to collect data related to dangerous driving conditions by, for example, a vehicle 124 that the device 122 is embedded with or otherwise traveling with, or for example, other vehicles on the roadway with sensor range of a device 122. The dangerous driving conditions may include any potential condition that may lead to danger or harm for a vehicle or operator for a given area. Some causes of a dangerous driving condition may include poor road surfaces (e.g., potholes), dangerous curves or intersection, road obstructions, difficult maneuvers, extreme traffic jams, sharp exit ramps, etc. Locations with dangerous driving conditions may be identified by detecting various metrics at locations that describe non-normal maneuvers or actions by vehicles or devices 122.

The devices 122 may also be configured to provide probe reports to the mapping system 121 while traversing a roadway network. The probe reports may include the dangerous driving condition data but also data related to normal operation of a vehicle, for example, including sensor and feature data about the roadway. Because only a small portion of the roadway may exhibit dangerous driving conditions, probe reports, however, may or may not indicate or identify such a dangerous driving condition. Analysis of the probe data to determine if a dangerous driving condition exists may be performed at a later time after collection. This probe data may be referred to as historical probe data. The historical probe data may be flagged for certain events or outliers that may indicate a dangerous driving condition, for example, sudden breaking i.e., sudden deceleration, jerks, a sudden lane change, sinuosity (switching in and out of lanes), etc. Analysis of the historical probe data is performed by the mapping system 121 to identify which location include possible dangerous driving conditions and which events or historical probe is incidental, e.g., not related to a dangerous driving condition. In an example, a probe report may indicate that a vehicle performed a sudden stop. This may be because of a dangerous driving condition. However, this may also be because of another driver or vehicle. Identifying which actions or events are indicative of dangerous driving conditions is challenging and may require multiple data points from multiple probe reports or other sensors.

Each vehicle and/or mobile device 122 may include position circuitry such as one or more processors or circuits for generating probe data. The probe data may include location data generated by receiving Global Navigation Satellite System (GNSS) signals and comparing the GNSS signals to a clock to determine the absolute or relative position of the vehicle and/or mobile device 122. The location data may be generated using embedded sensors or other data relating to the environment of a vehicle or device 122. The location data may include a geographic location such as a longitude value and a latitude value. In addition, the probe data may include a height or altitude.

The location of the vehicle may be determined at the lane level. A lane of the roadway is a section of the roadway designed for a single line of vehicles. The lanes of a roadway are arranged in a direction perpendicular to the direction of travel on the roadway. The lanes of the roadway may be divided by one or more lines. The probe data may be filtered into different lanes using one or more of a variety of techniques. Lane level map matching involves matching locational data to a lane. Different lane level map matching techniques may be used. In an example, the probe data is collected at a high enough spatial resolution by positional circuitry (for example GPS) to distinguish between lanes of the roadway. The device 122 or mapping system 121 may identify the locations of the lanes through clustering positions of vehicles as they traverse the roadway. The number of clusters corresponds to the number of lanes, and the default lane size is centered around the lane clusters. Lane level map matching may also use stored lane positions such as the boundaries for the lanes from memory or the geographic database 123. The mapping system 121 compares the location data from the probe data to the stored lane positions.

In another example, the lanes may be distinguished, and the probe data map matched through another type of positioning. For example, the mapping system 121 may analyze image data from a camera or distance data from a distancing system such as light detection and ranging (LiDAR). The mapping system 121 may access a fingerprint or other template to compare with the image data or the distance data. Based on the comparison, the mapping system 121 determines the lane of travel of the mobile device 122.

In another example, the device 122 detects lane lines. The lane lines may be detected from the camera data or distance data. Images of the road surface may be analyzed by the device 122 to identify patterns corresponding to lane lines that mark the edges of the lanes. Similarly, distance data such as LiDAR may include the location of lane markers.

In another example, the mapping system 121 or device 122 performs triangulation to determine the lane of travel of the mobile device 122. Triangulation may involve comparison of the angle, signal strength, or other characteristics of wireless radio signals received from one or more other devices. The positioning may be based on a received signal strength indicator (RSSI) measured at the mobile device 122. The RSSI may decrease proportionally to the square of the distance from the source of the signal. The positioning technique may analyze cellular signals received from multiple towers or cells. Position may be calculated from triangulation of the cellular signals. Several positioning techniques may be specialized for indoor applications such as pseudolites (GPS-like short range beacons), ultra-sound positioning, Bluetooth Low Energy (BTLE) signals (e.g., High-Accuracy Indoor Positioning, HAIP) and WiFi-Fingerprinting. Lane level map matching may also be performed using multiple probes from a device 122, for example by tracking the trajectory of the vehicle to determine lane changes or maneuvers.

The result of the lane level map matching is lane level map matching for each probe data. The probe data may be collected over time and include timestamps. In some examples, the probe data is collected at a predetermined time interval (e.g., every second, ever 100 milliseconds, or another interval). The probe data may also describe the speed, or velocity, of the mobile device 122. The speed may be determined from the changes of position over a time span calculated from the difference in respective timestamps. The time span may be the predetermined time interval, that is, sequential probe data may be used. In some examples, the probe data is collected in response to movement by the device 122 (i.e., the probe report's location information when the device 122 moves a threshold distance). The predetermined time interval for generating the probe data may be specified by an application or by the user. The interval for providing the probe data from the mobile device 122 to the server 125 may be may the same or different than the interval for collecting the probe data. The interval may be specified by an application or by the user.

The one or more devices 122 may also be configured to acquire image data using one or more cameras embedded in or in communication with the one or more devices 122. The image data may be included with the probe data and may be transmitted to the mapping system 121 for storage in the geographic database 123 and processing by the server 125. The image data may include metadata, for example, attributes about an image, such as its height and width, in pixels. The metadata may describe the content of the image, the date and time of the image, etc.

The one or more devices 122 may be in communication with the sensors or may directly acquire information. In an example, the one or more devices 122 may communicate with a vehicle's engine control unit (ECU) that controls a series of actuators on an internal combustion engine to ensure optimal engine performance. The ECU data may be provided in the probe reports. Braking sensors or other sensors configured to measure vehicle dynamics may provide information for the probe reports. A headlight sensor, wiper sensor, fog light sensor, etc. may also communicate with the one or more devices 122. These sensors may provide data that supports a dangerous condition determination for events such as weather conditions.

The mapping system 121 may be able to detect any non-normal or unexpected operations or maneuvers from one or more probe reports. Using the probe reports, the mapping system 121 may be able to reconstruct the path and operation of the device 122/vehicle. The mapping system 121 may be able to determine, for example, when braking occurs unexpectedly, when an abrupt lane change occurs, when the steering wheel is jerked one way or the other, when a vehicle is switching in and out of lanes, and/or when a speed of a vehicle is unexpected among other possible indications of a dangerous driving event. The context of the location of the device 122/vehicle may also be used when determining whether a dangerous driving metric has occurred or not, for example, the layout of the roadway or known construction events. Other external factors may include weather, time, weather related road conditions, or other transient road conditions. Types of weather include rain, snow, sunshine, hail, sleet, temperature or other examples. Weather related road conditions may include wet roads, snow on the roads, ice on the roads, or other examples. The time may be time of day, day of the week, day of the year or other examples.

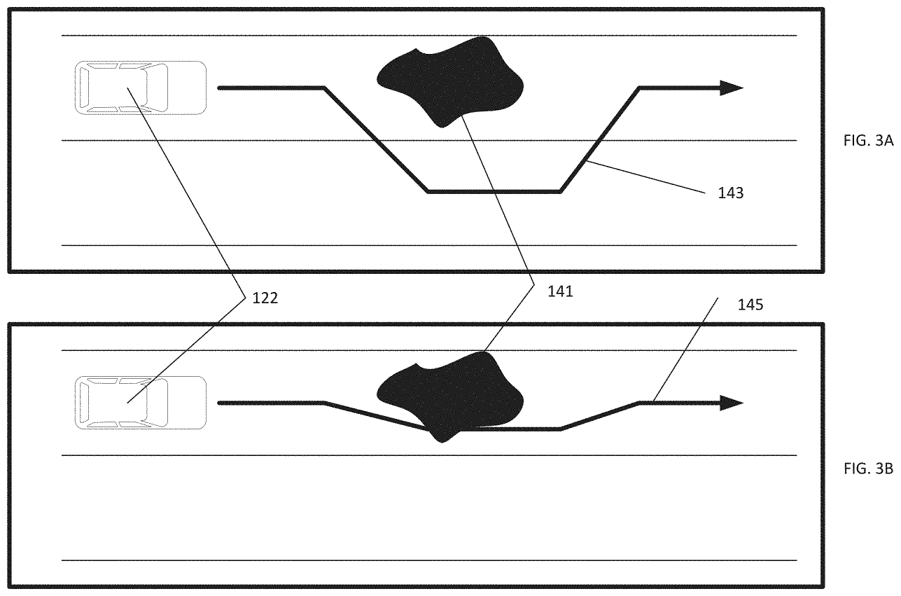

FIGS. 3A and 3B depict an example location that may be classified as including a dangerous driving condition 141. In FIGS. 3A and 3B, there are two vehicles/devices 122 traversing the same location on the roadway. The vehicle in FIG. 3A changes lanes 143 to avoid the pothole/obstruction/hazard 141. The vehicle in FIG. 3B swerves in their lane 145 to avoid the pothole/obstruction/hazard 141. These maneuvers 143, 145 may be detected by the device 122 and included in the probe data (or derived from the probe data by the mapping system 121). For a particular time epoch (1 min, 5 min, 15 min, etc.) there may be a collection of these actions. The mapping system 121 analyzes these actions 143, 145 by parsing the probe data in order to detect and classify if there is a dangerous driving condition 141.

The one or more devices 122 may communicate probe data/reports to the server 125 or mapping system 121. To communicate with the devices 122, systems or services, the mapping system 121 is connected to the network 127. The mapping system 121 may receive or transmit data through the network 127. The mapping system 121 may also transmit paths, routes, or dangerous condition probe data through the network 127. The mapping system 121 may also be connected to an OEM cloud that may be used to provide mapping services to vehicles via the OEM cloud or directly by the mapping system 121 through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols. The devices 122 may use Vehicle-to-vehicle (V2V) communication to wirelessly exchange information about their speed, location, heading, and roadway conditions with other vehicles, devices 122, or the mapping system 121. The devices 122 may use V2V communication to broadcast and receive omni-directional messages creating a 360-degree “awareness” of other vehicles in proximity of the vehicle. Vehicles equipped with appropriate software may use the messages from surrounding vehicles to determine potential threats or obstacles as the threats develop. The devices 122 may use a V2V communication system such as a Vehicular ad-hoc Network (VANET).

The probe data/reports, dangerous condition data (for example, artifacts), and other data is stored in the geographic database 123. The geographic database 123 is configured to store and provide information to and from at least the mapping system 121, server 125, and devices 122. The geographic database 123 may store and organize the data received from devices 122 and other sources. The data may be processed by one or more models or traffic editors provided by the mapping system 121. The geographic database 123 may include one or more indexes of geographic data. The indexes may include various types of indexes that relate the different types of data to each other or that relate to other aspects of the data contained in the geographic database 123. The indexes may include, for example, data relating to points of interest or roadway features. The point of interest data may include point of interest records including, for example, a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The geographic database 123 provides data for the dangerous driving condition classification model. The mapping data may include road types, road layouts, lane features, traffic lights/stop signs, etc. The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway.

The geographic database 123 is configured to store artifacts that relate to dangerous driving conditions. The artifacts may be generated by the mapping system 121 as described below after analysis of probe reports and classification of dangerous driving conditions.

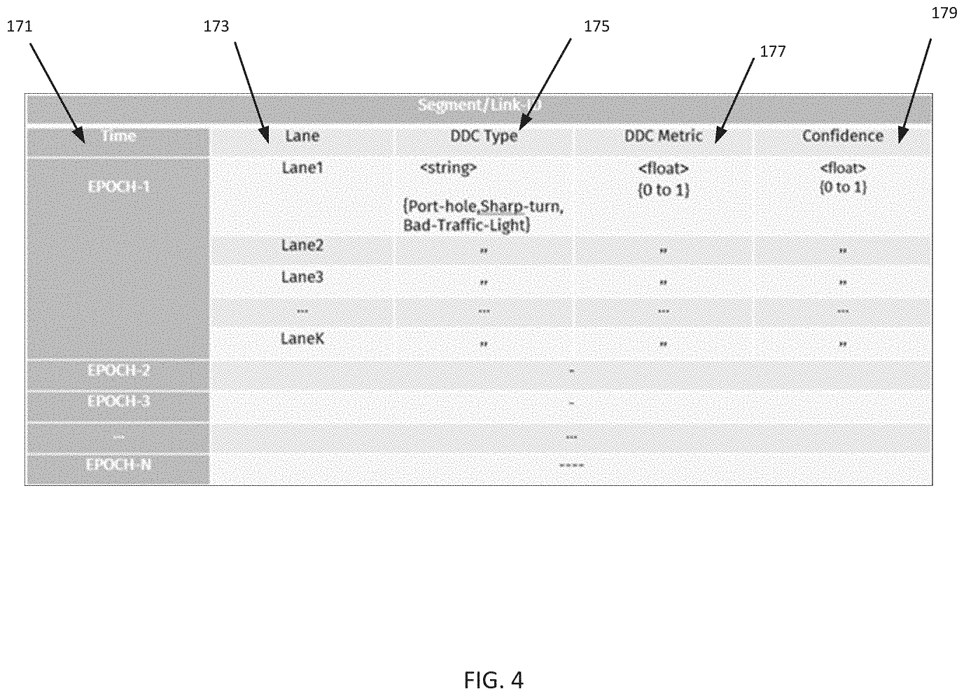

FIG. 4 describes some of the data that may be included in an index or datastore that is located in the geographic database 123. Each potential lane segment for each road segment may be covered, although some fields may be left blank or zeroed out if there is not sufficient information. FIG. 4 depicts a database entry for a segment/link that relates to a segment on the roadway. The data in this record includes the time 171, lane 173, DDC type 175, DDC metric 177, and confidence 179. This data is provided by the mapping system 121 as described below. The time 171 is broken up into epochs (for example, 1 min, 5 min, 15 min periods). The Lane 173 indicates the lane of the roadway. Some road segments may have multiple lanes, others only one. The DDC type 175 is the classified cause of the DDC provided by the mapping system 121. The DDC metric 177 relates to a severity of the DDC. The Confidence 179 is the confidence or probability that is returned from the mapping system 121 when classifying or categorizing the DDC. The Confidence 179 and DDC metrics 177 may be adjusted as new information is provided.

The data from the geographic database 123 may be analyzed and/or processed by the mapping system 121, for example by the server 125, in order to provide mapping services such as dangerous condition warning or predictions. The mapping system 121 may include multiple servers 125, workstations, databases, and other machines connected together and maintained by a map developer. The mapping system 121 may be configured to acquire and process data relating to roadway or vehicle conditions. For example, the mapping system 121 may receive and input data such as vehicle data, user data, weather data, road condition data, road works data, traffic feeds, etc. The data may be historical, real-time, or predictive. The data may be stored in an HD map, in a location graph, or in the geographic database 123 for use in location-based services and navigation-based services. The mapping service may also provide information generated from attribute data included in the database 123.

The server(s) 125 may be a host for a website or web service such as a mapping service and/or a navigation service. The mapping service may provide standard maps or HD maps generated from the geographic data of the database 123, and the navigation service may generate routing or other directions from the geographic data of the database 123. The mapping service may also provide information generated from attribute data included in the database 123. The server 125 may also provide historical, future, recent or current dangerous condition data for the links, segments, paths, or routes using historical, recent, or real-time collected data. The server 125 is configured to communicate with the devices 122 through the network 127. The server 125 is configured to receive a request from a device 122 for a route or maneuver instructions and generate one or more potential routes or instructions using data stored in the geographic database 123. The server 125 may also be configured to provide up to date information and maps to external geographic databases or mapping applications.

In an embodiment, the server 125 is configured to receive probe data from devices 122 that indicates one or more actions or operations that could indicate a dangerous driving condition. The probe data may indicate, for example, the vehicle experienced sudden deceleration, a jerky motion, a sudden lane change, sinuosity, or an unexpected velocity among other possible actions or metrics. The server 125 is configured to input the lane level map matched probe data and to output a classification for the dangerous driving condition. Referring back to FIGS. 3A and 3B, there server 125 is configured to input at least the two maneuvers performed by the two vehicles (assuming they are in the same time epoch). These maneuvers along with other data is used to determine that there is something dangerous about that lane portion that is causing non-normal or unsafe behavior by the vehicles.

A classification model may be used to determine if a location exhibits a dangerous driving condition. The classification model is configured to input the probe data and output a probabilities of potential causes. Different probabilities and thresholds may be used for determining when a location is experiences a dangerous driving condition. The classifier may provide a probability that is compared to a threshold. Probabilities and thresholds may, for example, be relative for an area compared to other nearby areas depending on the condition of the roadway or external events such as weather. The determination may be binary. Alternatively, a confidence value may be used to indicate the model's confidence that a dangerous driving condition is occurring or ongoing at a location.

In an embodiment, the dangerous driving condition classification model is trained using machine learning techniques. The dangerous driving condition classification model may be, for example, a classifier that is trained using supervised learning. The dangerous driving condition classification model may classify, based on the input probe data, whether or not a location exhibits a dangerous driving condition. The dangerous driving condition classification model may include a neural network that is defined as a plurality of sequential feature units or layers. Sequential is used to indicate the general flow of output feature values from one layer to input to a next layer. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction based on the input data. The features are learned to reconstruct lower-level features (i.e., features at a more abstract or compressed level). Each node of the unit represents a feature. Different units are provided for learning different features. Various units or layers may be used, such as convolutional, pooling (e.g., max pooling), deconvolutional, fully connected, or other types of layers. Within a unit or layer, any number of nodes is provided. For example, 100 nodes are provided. Later or subsequent units may have more, fewer, or the same number of nodes.

Unsupervised learning may be used to compute classification, based on the distribution of the samples, using methods such as k-nearest neighbor. In supervised learning, the classification step may happen in the last layer, and takes the key features of the sample as input from the previous layers. There are different classification functions, depending on the use case. An embodiment uses a Softmax function—where for each sample, the result is the probability distribution over the classes.

Different neural network configurations and workflows may be used for the network such as a convolution neural network (CNN), deep belief nets (DBN), or other deep networks. CNN learns feed-forward mapping functions while DBN learns a generative model of data. In addition, CNN uses shared weights for all local regions while DBN is a fully connected network (e.g., including different weights for all regions of a feature map. The training of CNN is entirely discriminative through backpropagation. DBN, on the other hand, employs the layer-wise unsupervised training (e.g., pre-training) followed by the discriminative refinement with backpropagation if necessary. In an embodiment, the arrangement of the trained network is a fully convolutional network (FCN). Alternative network arrangements may be used, for example, a 3D Very Deep Convolutional Networks (3D-VGGNet). VGGNet stacks many layer blocks containing narrow convolutional layers followed by max pooling layers. A 3D Deep Residual Networks (3D-ResNet) architecture may be used. A Resnet uses residual blocks and skip connections to learn residual mapping.

The training data for the model/network (and other networks) includes ground truth data or gold standard data, for example actual detected or identified dangerous condition data that has been verified, for example, by on the ground personal. Ground truth data and gold standard data is data that includes correct or reasonably accurate labels that are verified manually or by some other accurate method. The training data may be acquired at any point prior to inputting the training data into the network. In an example, a dangerous condition may be identified by on the ground personal. Historical probe data or other sensor data may be located or accessed for a period of time that the verified dangerous condition was present. The combination of this probe data (that may indicate certain actions by vehicles to avoid the dangerous condition) and the classified dangerous condition constitute the ground truth data for which the model may be trained on. In the example of FIGS. 3A and 3B described above, a certain percentage of vehicles may have swerved. A percentage of vehicles may have changed lanes. A percentage of vehicles may have decreased their speed, etc. This data is used by the model during training to identify patterns so that the model may identify a dangerous driving condition when presented with probe data in real time.

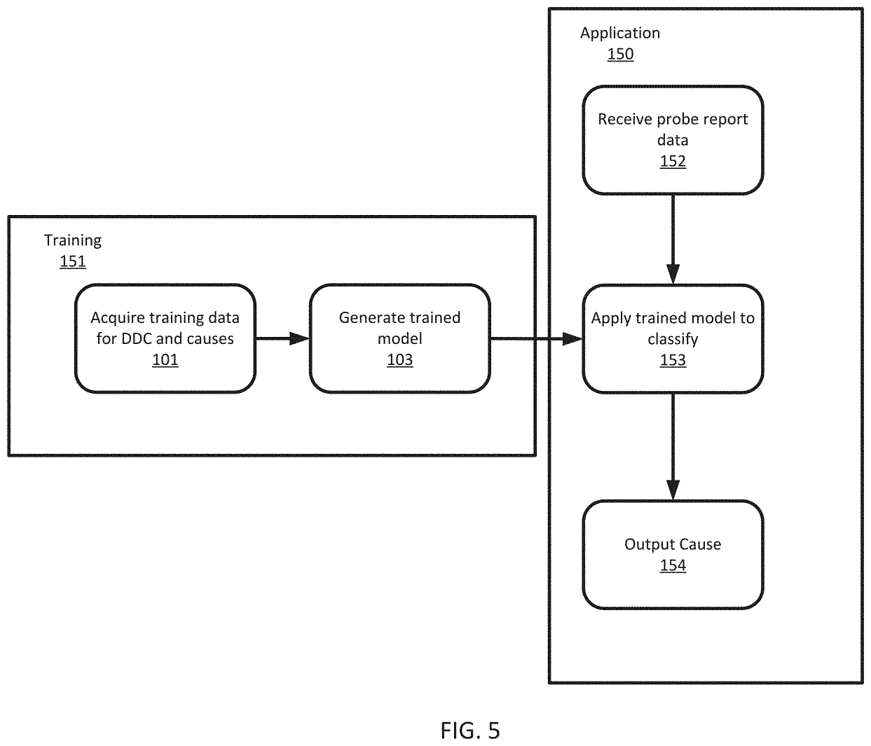

FIG. 5 depicts an example of the training and application of the model. The flowchart includes two stages, a training stage 151 for generating or training the dangerous driving condition classification model using a collection of training data (labeled data) and an application stage 150 for applying the generated/trained dangerous driving condition classification model to new unseen (unlabeled) data. The training stage 151 includes acquiring 101 training data and inputting the training data into the dangerous driving condition classification model in order to generate 103 a trained dangerous driving condition classification model. The output is a trained dangerous driving condition classification model that is applied 153 in the application stage 150. The application stage 150 includes receiving a real-time data from devices, applying 153 the trained dangerous driving condition classification model that was trained during the training stage 151 to identify or classify dangerous conditions given driving events, and outputting the classification 154. The dangerous driving condition classification model may also output a confidence value that indicates the confidence of the model that the location is experiencing a dangerous driving condition. The confidence value may be adjusted over time as additional data is input into the dangerous driving condition classification model. The training stage 151 may be performed at any point prior to the application stage 150. The training stage 151 may be repeated after new training data is acquired. New training data may, for example, include additional dangerous condition event data. The application stage 150 may be performed at any point after the training stage 151 generates the trained network and real-time data is received.

In an example operation the dangerous driving condition classification model inputs the training data (e.g., probe data, sensor data, image data, mapping data, or any other data that may be relevant to the dangerous driving condition that the dangerous driving condition classification model/mapping system 121 has access to) and outputs a prediction for whether or not a dangerous condition exists. The prediction is compared to the annotations from the training data. A loss function may be used to identify the errors from the comparison. The loss function serves as a measurement of how far the current set of predictions are from the corresponding true values. Some examples of loss functions that may be used include Mean-Squared-Error, Root-Mean-Squared-Error, and Cross-entropy loss. Mean Squared Error loss, or MSE for short, is calculated as the average of the squared differences between the predicted and actual values. Root-Mean Squared Error is similarly calculated as the average of the root squared differences between the predicted and actual values. For cross-entropy loss each predicted probability is compared to the actual class output value (0 or 1) and a score is calculated that penalizes the probability based on the distance from the expected value. The penalty may be logarithmic, offering a small score for small differences (0.1 or 0.2) and enormous score for a large difference (0.9 or 1.0). During training and over repeated iterations, the network attempts to minimize the loss function as the result of a lower error between the actual and the predicted values means the network has done a good job in learning. Different optimization algorithms may be used to minimize the loss function, such as, for example, gradient descent, Stochastic gradient descent, Batch gradient descent, Mini-Batch gradient descent, among others. The process of inputting, outputting, comparing, and adjusting is repeated for a predetermined number of iterations with the goal of minimizing the loss function.

One adjusted and trained, the dangerous driving condition classification model is configured to classify dangerous driving conditions that occur during a time epoch. The time epoch may be a time period used to identify the dangerous driving condition. The time period may be a time of day, day of week or day of the year. The time epoch may be determined by holidays or business hours. The time epoch may have various duration such as 1 minute, 15 minutes, 1 hour, or another value. As an example, the model may acquire and analyze data from recent time epochs (for example, the current epoch or a just closed epoch) to determine if there is a dangerous driving condition present at a location (or ongoing). The model may process incoming probe data in real time or may group the probe data into a set for a time period. The model analyzes whether or not the probe data of, for example the most recent epoch, is similar to historical probe data for locations that had previously been classified as experiencing a dangerous driving condition. In an example, if the driving metrics (dangerous driving condition metrics) are similar, the model may classify a location as experiencing a similar event. If a certain percentage of drivers or vehicles perform certain actions, the model may predict that the location is similarly experiencing a dangerous driving condition.

In an embodiment, locations with high recurring dangerous driving condition metrics may be identified and the top 10% may be sent to the traffic editors for a review. The traffic editors may investigate it the location using cameras and other sources of traffic information to ascertain the cause and then categorize it. This manual review may be performed along with the model classification or as a verification technique.

In an embodiment, the output of the dangerous driving condition classification model is a location, a classification, a dangerous driving condition metric value, and a confidence value. This information may be combined into a dangerous driving condition artifact and stored in the geographic database. In an embodiment, the dangerous driving condition classification model is configured to output a dangerous driving condition metric value that relates to a severity of the dangerous driving condition. The dangerous driving condition metric value may be based on annotated data from the training data set and may be provided by traffic editors. In an embodiment, the dangerous driving condition classification model is configured to output a confidence value. The confidence value represents the confidence the model has in its classification/prediction. The confidence value may change over time as new data is acquired. This architecture illustrates how embodiments use historical probe inputs to generate the dangerous driving condition artifact and then take real-time detection input to monitor the dangerous driving condition locations in the artifact and use this to publish the content indicating that the dangerous driving condition event is still happening (on-going). New data confirming the dangerous driving condition event raises the confidence metric of the dangerous driving condition event and if there is no real-time data, the dangerous driving condition artifact will be published to the automotive cloud with a lower confidence. The dangerous driving condition warning messages published helps for smoother navigation and safer route choice for drivers.

When the mapping system 121 detects and classifies a dangerous driving condition, the mapping system 121/geographic database 123 may publish this information as an artifact for use by navigation systems, devices 122, or mapping services. As a result, for example, navigation systems may access the artifact and issue instructions (e.g., stay left, change lanes) to avoid the dangerous location. Similarly, anonymous or assisted driving vehicles may avoid dangerous locations or select the safest lanes based on attributes of the roadway such as through a sharp curve. For these embodiments, high granularity between lanes and along lanes that defines where the dangerous conditions begin and end. High precision navigation is provided to vehicles by high-definition maps for navigation, and it is important to provide information in the map that has high granularity and precision. This will help reduce driving errors and accidents.

In an embodiment, a warning system provides details of dangerous driving conditions to a device 122 as the device 122/vehicle traverses the roadway. For example, a warning may be displayed using a navigation application such as “INCREASED RISK” for a location indicating that there is a dangerous driving condition on an upcoming lane or segment of the roadway.

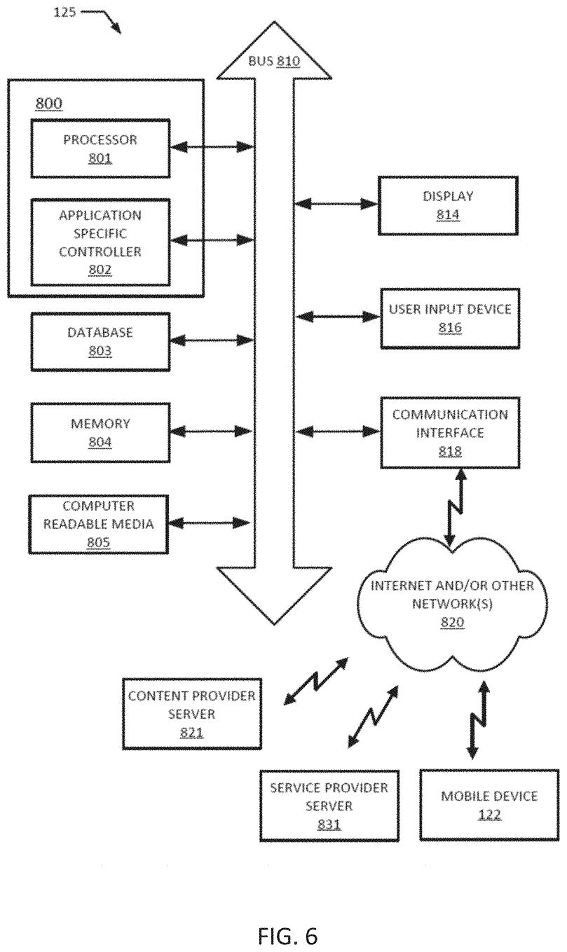

FIG. 6 depicts an example server 125 for the system of FIG. 2 that trains and provides a model that classifies dangerous driving conditions. The server 125 is further configured to monitor classified dangerous driving conditions and adjust a confidence value based on real-time probe reports. The server 125 may include a bus 810 that facilitates communication between a controller 800 that may be implemented by a processor 801 and/or an application specific controller 802, which may be referred to individually or collectively as the controller 800, and one or more other components including a database 803, a memory 804, a computer readable medium 805, a display 814, a user input device 816, and a communication interface 818 connected to the internet and/or other networks 820. The contents of database 803 are described with respect to database 123. The server-side database 803 may be a master database that provides data in portions to the database of the mobile device 122. Additional, different, or fewer components may be included. The memory 804 and/or the computer readable medium 805 may include a set of instructions that can be executed to cause the server 125 to perform any one or more of the methods or computer-based functions disclosed herein. The server 125 may be in communication through the network 820 with a content provider server 821 and/or a service provider server 831. The server 125 may provide mapping or navigation related services or data to the content provider server 821 and/or the service provider server 831. The content provider may include device manufacturers that provide location-based services.

The server 125 is configured to train a model using historical probe data. The Server 125 is configured to detect dangerous driving condition events using the trained model and probe data (historical and real-time). The server 125 is configured to generate dangerous driving condition artifacts based on the dangerous driving condition events and dangerous driving condition event patterns. The server 125 is configured to provide the dangerous driving condition artifacts to devices 122. In an embodiment, the server 125 acquires probe data from devices.

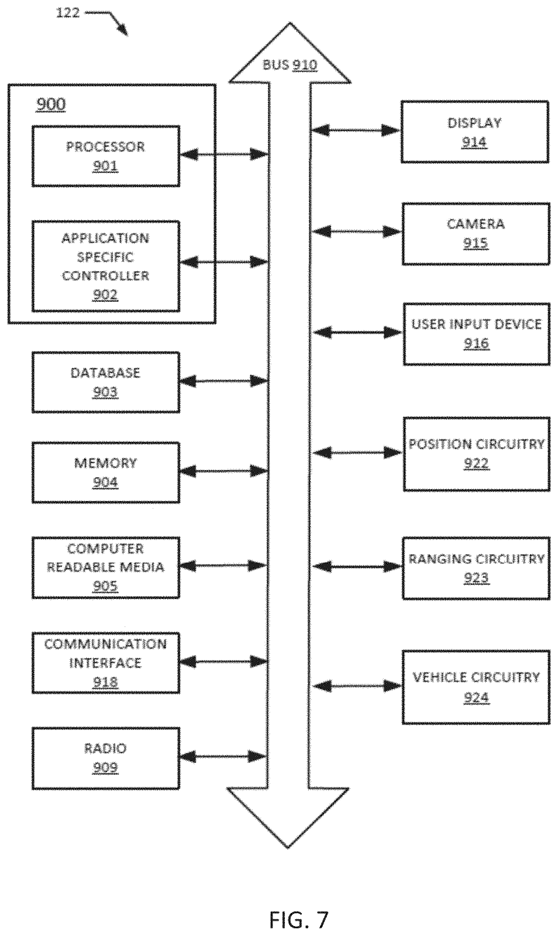

FIG. 7 illustrates an example mobile device 122 for the system of FIG. 1. The mobile device 122 is configured to provide historical and real-time probes for use in detecting and classifying dangerous driving conditions. The mobile device 122 is further configured to receive dangerous driving condition event warnings from the server 125 and take appropriate actions in response. The mobile device 122 may include a bus 910 that facilitates communication between a controller 900 that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, ranging circuitry 923, and vehicle circuitry 924. The contents of the database 903 are described with respect to the geographic database 123. The device-side database 903 may be a user database that receives data in portions from the database 903 of the mobile device 122. The communication interface 918 connected to the internet and/or other networks (e.g., network 127 shown in FIG. 1). The vehicle circuitry 924 may include any of the circuitry and/or devices described with respect to FIG. 6. Additional, different, or fewer components may be included.

The server 125 may be deployed in the cloud and accessible using a network 127 as described above. The server 125 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The one or more devices 122 acquire real-time probe data that is used to adjust a dangerous driving condition value and a confidence value. The dangerous driving condition value may be determined by the frequency and severity of the dangerous driving condition event in terms of impact on safe driving. The confidence is the degree of certainty of the source of data or the chances of its re-occurrence.

The server 125 trains a model that is configured to classify dangerous driving condition events based on identified dangerous driving condition metrics such as sudden breaking i.e., sudden deceleration, jerks, sudden lane changes, sinuosity (switching in and out of lanes), and/or isolated zero speed cluster in a probe trajectory among other metrics. When these dangerous driving condition metrics are reoccurring, the server 125 may aggregate them for a location and determine if and then classify a dangerous driving condition event.

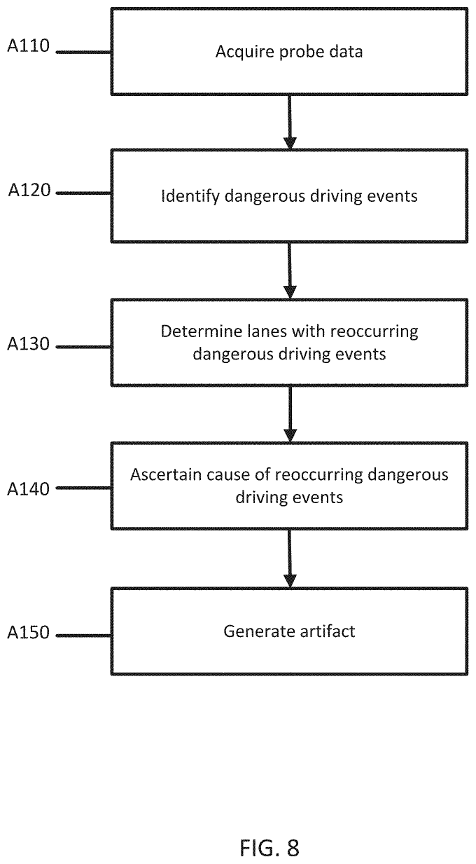

FIG. 8 depicts an example workflow for detecting dangerous driving conditions using the server 125 of FIG. 6 and the device 122 of FIG. 7. As presented in the following sections, the acts may also in part be performed using any combination of the components indicated in FIG. 1, 6, or 7. For example, certain acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A110, the server 125 (mapping server 125), acquires historical lane-level map matched probe data for a plurality of locations.

The data acquired by a device 122 is map-matched to a road segment or node, in particular a specific lane of the road segment. The device 122 is configured to determine its location using the position circuitry 922, ranging circuitry 923, vehicle circuitry 924, and the geographic database 123. The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device 122. The gyroscope is operable to detect, recognize, or measure the current orientation, or changes in orientation, of a mobile device 122. Gyroscope orientation change detection may operate as a measure of yaw, pitch, or roll of the mobile device 122.

The device 122 may also be configured to acquire the data for the location using one or more sensors and/or the geographic database 123. The one or more sensors may include ranging circuitry 923, image/video cameras, weather sensors, occupant sensors, and any other vehicle sensor that collects data about the vehicle or the environment around the vehicle. For example, the ranging circuitry 923 may include a LIDAR system, a RADAR system, a structured light camera system, SONAR, or any device configured to detect the range or distance to objects from the mobile device 122. The controller 900 of the device 122 may also communicate with a vehicle engine control unit (ECU) that operates one or more driving mechanisms (e.g., accelerator, brakes, steering device). Alternatively, the mobile device 122 may be the vehicle ECU that operates the one or more driving mechanisms directly.

At act A120, the server 125 identifies dangerous driving events in the historical lane-level map matched probe data on one or more lane locations. Dangerous driving events may include abnormal driving maneuvers or actions such as when braking occurs unexpectedly, when an abrupt lane change occurs, when the steering wheel is jerked one way or the other, when a vehicle is switching in and out of lanes, and/or when a speed of a vehicle is unexpected.

At act A130, the server 125 determines one or more reoccurring lane locations that exhibit reoccurring dangerous driving events. A single dangerous driving event such as a vehicle swerving may not indicate a dangerous driving condition. For example, a vehicle may swerve to avoid a temporary hazard or just be a bad driver. However, reoccurring events, such as when multiple vehicle swerve at a location may indicate that there is something additional occurring that location. While the server 125 may analyze every location, focusing on reoccurring locations may save processing power and may provide quicker and more efficient analysis of dangerous driving events.

At act A140, the server 125 ascertains a cause of the reoccurring dangerous driving events for each of the one or more reoccurring locations. The server 125 trains, configures, and stores a model to detect and classify dangerous driving conditions. The at least one model may be trained, configured, and updated at the mapping system 121, for example by the server 125. The server 125 may iteratively train or configure the model using a set of historical training data that includes annotated (known or identified) dangerous driving condition events. The training data is input into the model which outputs a classification/categorization of the dangerous driving condition event. The training data may include probe data for a location and a time epoch. The output is a determination of whether a dangerous driving condition exists and if so, what the cause of the dangerous driving condition is. In an example, the probe data includes a series of different maneuvers that vehicles took at the location during the time epoch. The output may be a list of probabilities of events at the location, for example 30% that the location is normal, 20% that the location has a pothole, and 50% that there is a stopped vehicle. In this example, the classification is that yes there is a dangerous driving condition and the cause is a stopped vehicle. In another example, the probabilities may be that 50% roadway configuration is dangerous, 40% that there is no dangerous driving condition, and 10% that there is an accident. The output may be required to exceed a threshold classification probability to be classified as a dangerous driving condition. The output is compared the annotation. The comparison is used to adjust the model/network until the model is optimized. For the machine learning task described above and herein, the model (also referred to as machine learning model, neural network, or network) may be trained using one or more optimization algorithms such as gradient decent. Training using an optimization method such as gradient descent includes determining how close the model estimates the target function. The determination may be calculated a number of different ways that may be specific to the particular model being trained. The cost function involves evaluating the parameters in the model by calculating a prediction for the model for each training instance in the dataset and comparing the predictions to the actual output values and calculating an average error value (such as a value of squared residuals or SSR in the case of linear regression). In a simple example of linear regression, a line is fit to a set of points. An error function (also called a cost function) is defined that measures how good (accurate) a given line is. In an example, the function inputs the points and return an error value based on how well the line fits the data. To compute the error for a given line, in this example, each point (x, y) is iterated in the data set and the sum the square distances between each point's y value and the candidate line's y value is calculated as the error function. Gradient descent may be used to minimize the error functions. Given a function defined by a set of parameters, gradient descent starts with an initial set of parameter values and iteratively moves toward a set of parameter values that minimize the function. The iterative minimization is based on a function that takes steps in the negative direction of the function gradient. A search for minimizing parameters starts at any point and allows the gradient descent algorithm to proceed downhill on the error function towards a best outcome. Each iteration updates the parameters that yield a slightly different error than the previous iteration. A learning rate variable is defined that controls how large of a step that is taken downhill during each iteration.

Alternative optimization algorithms may be used. For example, stochastic gradient decent is a variation of gradient decent that may be used. Nesterov accelerated gradient (NAG) is another algorithm that solves a problem of momentum when an algorithm reaches the minima i.e., the lowest point on the curve. Adaptive Moment Estimation (Adam) is another method that computes adaptive learning rates for each parameter. In addition to storing an exponentially decaying average of past squared gradients like AdaDelta, Adam also keeps an exponentially decaying average of past gradients M(t), similar to momentum. Depending on the model, different types of optimization algorithms, e.g., first order or second order (hessian) may be used. Any algorithm that executes iteratively by comparing various solutions until an optimum or a satisfactory solution is found may be used to train the model. The trained model may be stored at the server 125, for example in the memory 804. The trained model may be deployed to a networked cloud-based environment or to one or more devices 122.

At act A150, the server 125 generates and stores an artifact for each of the one or more reoccurring locations that includes the ascertained dangerous driving condition type and a time the dangerous driving condition event occurs. The artifact may be stored in the geographic database.

Over time, dangerous driving conditions evolve or change (or disappear). Obstructions are removed, hazards are fixed, roadway configurations are corrected, etc. A pothole that exists at a first time may be fixed at a second time so that when a vehicle traverses the location at a third time there no longer is a dangerous driving condition. During the classification/categorization process, the mapping system 121 may provide a confidence value for the dangerous driving condition that relates to change that the dangerous driving condition actually exists. With a lot of probe reports that indicate certain actions, the mapping system 121 may be more confident in its classification than if there was only a few or only one probe report that indicated certain actions. Over time as more actions are detected and the metrics increase, the mapping system 121 may become more confident in its classification. Similarly, if subsequent probe reports do not indicate certain actions, the mapping system 121 may be less confident that the dangerous driving condition still exists. In this way, both real-time warnings and updates may be provided by the mapping system 121 as the roadway evolves over time.

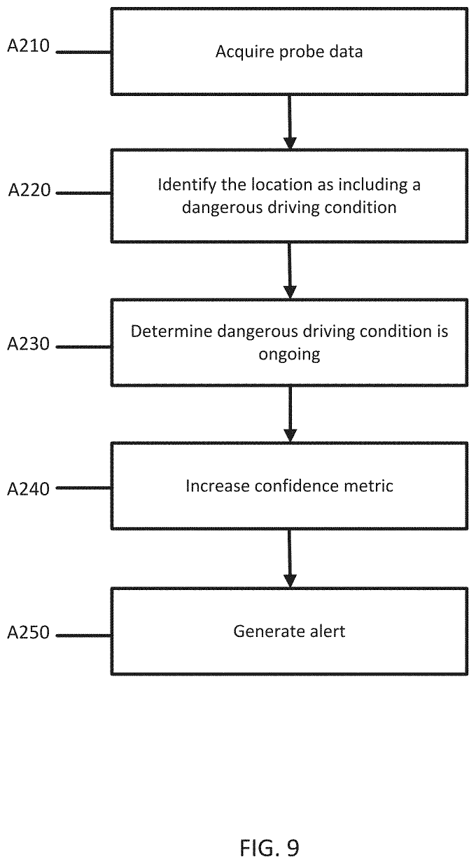

FIG. 9 depicts an example workflow for providing real-time event warnings using the server 125 of FIG. 6 and the device 122 of FIG. 7. As presented in the following sections, the acts may also in part be performed using any combination of the components indicated in FIG. 1, FIG. 5, or FIG. 6. For example, certain acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A210, the server 125 acquires real-time probe data for a location from a device 122. At act A220, the server 125 identifies the location as a dangerous driving condition location based on a dangerous driving condition artifact stored in the geographic database 123. The dangerous driving condition artifact may include a location, a time epoch, a dangerous driving condition metric value, and a confidence value. The location is a lane or portion of a lane on a road segment. The time epoch is a period of time, for example 1 min, 5 minutes, 15 minutes, etc. The dangerous driving condition metric value may be a measure of how serious the dangerous driving condition is. The confidence value is a measure of the confidence of a model that the dangerous driving condition exists and is ongoing. These values may be stored in an index or datastore in the geographic database 123. The geographic database 123 includes information about one or more geographic regions.

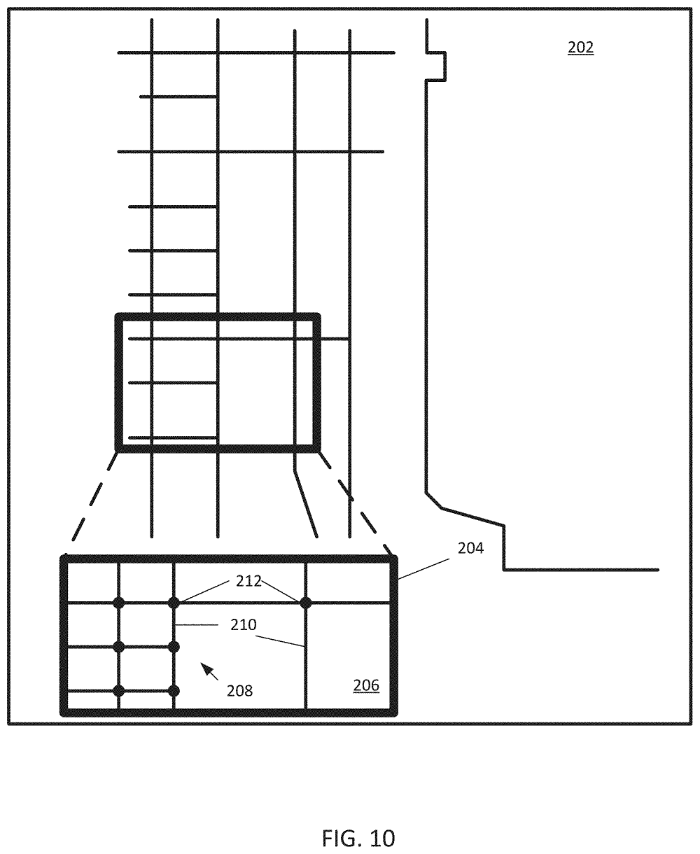

FIG. 10 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 10 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

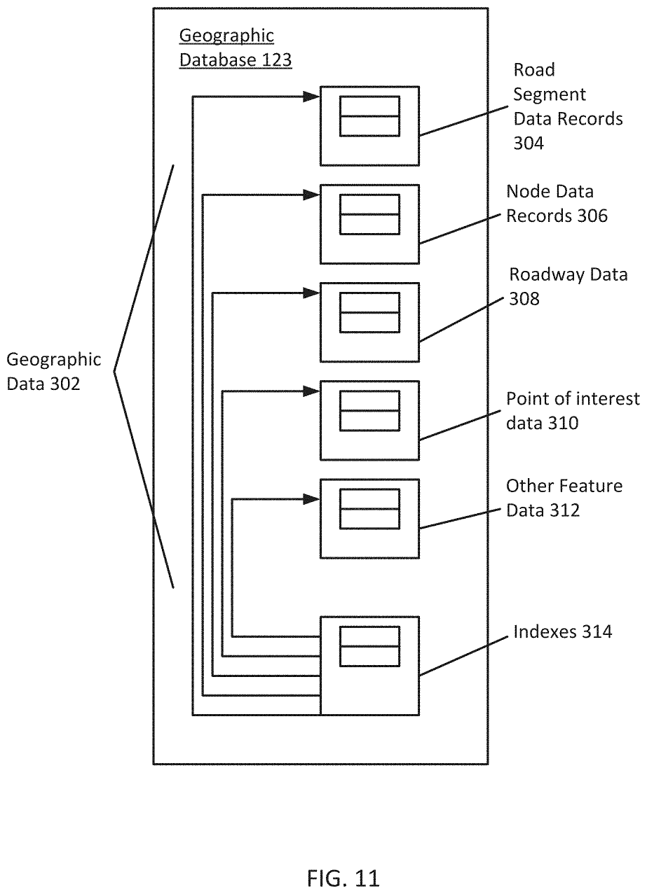

As depicted in FIG. 11, in one embodiment, the geographic database 123 contains geographic data 302 that represents some of the geographic features in the geographic region 202 depicted in FIG. 10. The data 302 contained in the geographic database 123 may include data that represent the road network 208. In FIG. 9, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges, etc. The roadway data 308 may be further stored in sub-indices that account for different types of roads or features. The point of interest data 310 may include data or sub-indices or layers for different types of points of interest. The point of interest data may include point of interest records comprising a type (e.g., the type of point of interest, such as restaurant, fuel station, hotel, city hall, police station, historical marker, ATM, golf course, truck stop, vehicle chain-up stations, etc.), location of the point of interest, a phone number, hours of operation, etc. The feature data 312 may include other roadway features.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

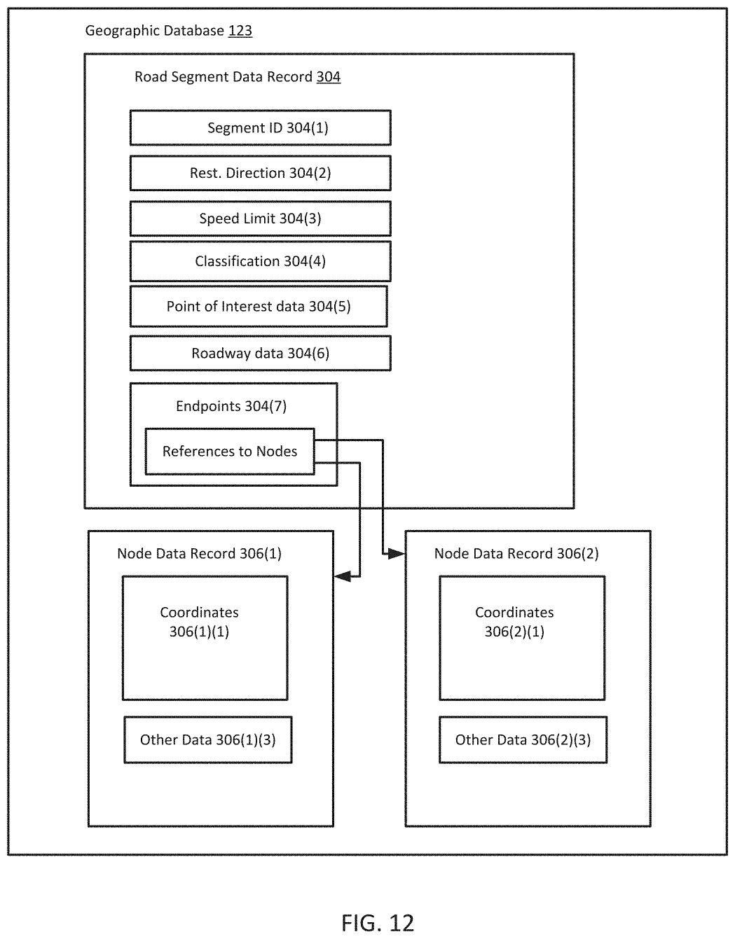

FIG. 12 shows some of the components of a road segment data record 304 contained in the geographic database 123 according to one embodiment. The road segment data record 304 may include a segment ID 304(1) by which the data record can be identified in the geographic database 123. Each road segment data record 304 may have associated information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include classification data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes lane configurations. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, etc. The various attributes associated with a road segment may be included in a single road segment record or may be included in more than one type of record which cross-references each other. For example, the road segment data record 304 may include data identifying what turn restrictions exist at each of the nodes which correspond to intersections at the ends of the road portion represented by the road segment, the name or names by which the represented road segment is known, the street address ranges along the represented road segment, and so on.

FIG. 12 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 10, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes.

The data in the geographic database 123 may be organized using a graph that specifies relationships between entities. A location graph is a graph that includes relationships between location objects in a variety of ways. Objects and their relationships may be described using a set of labels. Objects may be referred to as “nodes” of the location graph, where the nodes and relationships among nodes may have data attributes. The organization of the location graph may be defined by a data scheme that defines the structure of the data. The organization of the nodes and relationships may be stored in an ontology which defines a set of concepts where the focus is on the meaning and shared understanding. These descriptions permit mapping of concepts from one domain to another. The ontology is modeled in a formal knowledge representation language which supports inferencing and is readily available from both open-source and proprietary tools.

The artifact may be generated by the server 125 using a trained model that is configured to input probe data and output a classification of a dangerous driving condition event (when applicable). The trained model may also be configured to output a confidence value or metric.

Referring back to FIG. 9, at act A230, the server 125 determines that the dangerous driving condition event is ongoing based on the real-time probe data. The device 122 may communicate with the server 125 to provide probe data. The communication interface 918 and/or communication interface 918 may include any operable connection. An operable connection may be one in which signals, physical communications, and/or logical communications may be sent and/or received. An operable connection may include a physical interface, an electrical interface, and/or a data interface. The communication interface 918 provides for wireless and/or wired communications in any now known or later developed format. The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

Each probe device 122 that traverses the location may provide additional information to the server 125. The server 125 may bundle the information for an epoch and input the bundle into the model which again attempts to provide a classification. Data from previous epochs may also be used and weighted differently (as it is older).

At act A240, the server 125 adjusts a confidence metric of the dangerous driving condition artifact. The dangerous driving condition event may be ongoing (or permanent). If the probability is lower, the confidence metric may be lowered. If the probability is higher, the confidence metric may be raised.

At act A250, the server 125 publishes a dangerous driving condition event warning when the confidence metric exceeds a predefined threshold. The device 122 generates an alert for the location based on the probability score. In an embodiment, the device 122 determines, that the probability score exceeds a threshold score. The threshold score may be set by the device 122, an operator, the mapping system 121, the server 125 or by other means. The threshold may be region specific or may be based on the type of vehicle that is being driven. Different fleets or organizations may have different standards for safety. Different autonomous vehicles may also be better equipped to handle certain circumstances.

The alert may be, for example a routing instruction to take a different route. The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

A user may interact with the map/navigation system/alert using an input device 916. The input device 916 may be one or more buttons, keypad, keyboard, mouse, stylus pen, trackball, rocker switch, touch pad, voice recognition circuit, or other device or component for inputting data to the mobile device 122. The input device 916 and display 914 may be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The alert and probability information may be used to be aware of such risks or avoid dangerous driving conditions. In an example, when the vehicle is approaching a dangerous driving condition, the device 122 might prompt the user to take over the control of the vehicle. The controller 900 may reduce speed or behaviors in such areas.

In response to the alert, a vehicle or driver may decide to take a different route if the dynamically computed risk is over a given threshold. Vehicles in both directions may be informed of the increased risk for a specific time period. Pedestrians may be informed that dangerous driving is more likely to occur when a vehicle is stopped on a street with given characteristics (e.g., one driving lane in each direction). Police/assistance may be notified to come and support faster the incident that occurred in such areas with higher associated risk. Police or emergency services may also preemptively come and control to prevent such dangerous behaviors in a proactive way thanks to the prediction capability.

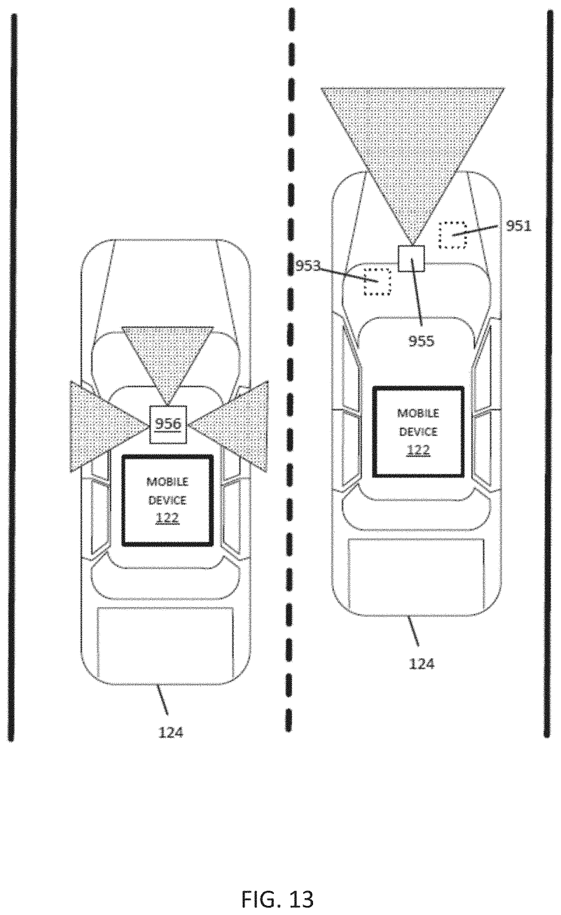

In an embodiment, the device 122 may alert or otherwise provide instructions for an autonomous vehicle to perform a maneuver. FIG. 13 illustrates an exemplary vehicle 124 for providing location-based services, navigation services, or applications using the systems and methods described herein as well as collecting data for such services or applications described herein. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively, or additionally, the one or more detectors or sensors may include an accelerometer built or embedded into or within the interior of the vehicle 124. The vehicle 124 may include one or more distance data detection device or sensor, such as a LIDAR device. The distance data detection sensor may include a laser range finder that rotates a mirror directing a laser to the surroundings or vicinity of the collection vehicle on a roadway or another collection device on any type of pathway.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server 125. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the lane marking indicators (lane marking type, lane marking intensity, lane marking color, lane marking offset, lane marking width, or other characteristics) received from geographic database 123 and the server 125 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) received from geographic database 123 and the server 125 and driving commands or navigation commands.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) received from geographic database 123 and the server 125 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) received from geographic database 123 and the server 125 and driving commands or navigation commands.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for detecting dangerous driving conditions, the method comprising:
acquiring lane-level map matched probe data for a plurality of locations;
identifying dangerous driving events in the lane-level map matched probe data on one or more lane locations;
determining one or more reoccurring lane locations that exhibit reoccurring dangerous driving events;
ascertaining a cause of the reoccurring dangerous driving events for each of the one or more reoccurring locations; and
generating and storing an artifact for each of the one or more reoccurring locations that includes an ascertained dangerous driving condition type.

2. The method of claim 1, wherein the lane-level map matched probe data is lane-level map matched by using historical raw GPS probe positions to create a layer of abstraction over a map that is used to generate lane probabilities of real-time probes based on their lateral position.

3. The method of claim 1, wherein the dangerous driving events comprise at least one of sudden breaking, sudden deceleration, jerky motion, a sudden lane change, sinuosity, or an isolated zero speed cluster in a probe trajectory.

4. The method of claim 1, wherein determining comprises identifying locations that exceed a predefined threshold of dangerous driving events for a time period.

5. The method of claim 1, wherein ascertaining the cause of the reoccurring dangerous driving events comprises:
inputting the reoccurring dangerous driving events for a respective location into a machine trained model configured to classify causes of dangerous driving conditions; and
outputting by the machine trained model, a classification for the cause of the reoccurring dangerous driving events.

6. The method of claim 5, wherein the machine trained model is configured to input a plurality of probe reports for the respective location for a respective time epoch.

7. The method of claim 5, wherein the artifact further comprises a confidence value for the ascertained dangerous driving condition, the confidence value representative of a probability of the classification by the machine trained model.

8. The method of claim 7, further comprising:
acquiring real-time data for the ascertained dangerous driving condition, wherein the real-time data is used to adjust the confidence value.

9. The method of claim 1, wherein the cause comprises at least one of a poor road surface, a dangerous curves or intersection, a road obstruction, a difficult maneuver, or a share exit ramp.

10. A method for providing real-time event warnings, the method comprising:
acquiring real-time probe data for a location;
identifying the location as experiencing a dangerous driving condition based on a dangerous driving condition artifact;
determining that the dangerous driving condition is ongoing based on the real-time probe data;
increasing a confidence metric of the dangerous driving condition artifact; and
publishing a dangerous driving condition event warning when the confidence metric exceeds a predefined threshold.

11. The method of claim 10, wherein the dangerous driving condition comprises one of a poor road surface, a dangerous curves or intersection, a road obstruction, a difficult maneuver, or a share exit ramp.

12. The method of claim 10, wherein determining comprises:
inputting the real-time probe data and data from the dangerous driving condition artifact into a machine trained model configured to classify causes of dangerous driving conditions; and
outputting by the machine trained model, a classification and confidence metric for the dangerous driving condition.

13. The method of claim 10, wherein the real-time probe data is lane-level map matched.

14. The method of claim 10, further comprising:
receiving additional real-time probe data for the location;
determining that the dangerous driving condition has ended based on the additional real-time probe data; and
decreasing the confidence metric of the dangerous driving condition artifact.

15. A system for detecting dangerous driving conditions, the system comprising:
one or more probe devices configured to acquire probe data;
a geographic database configured to store probe data and artifact data related to dangerous driving conditions; and
a mapping server configured to aggregate the probe data for locations and time periods, determine, based on probe data for a respective location and respective time period, that a dangerous driving condition exists for the respective location and respective time period, and generate and store artifact data for the dangerous driving condition.

16. The system of claim 15, wherein the dangerous driving events comprise at least one of a poor road surface, a dangerous curves or intersection, a road obstruction, a difficult maneuver, or a share exit ramp.

17. The system of claim 15, wherein the mapping server is configured to determine that the dangerous driving condition exists using a machine trained dangerous driving condition classification model.

18. The system of claim 15, wherein the mapping server is configured to generate a confidence metric for the determined dangerous driving condition and store the confidence metric in the artifact data.

19. The system of claim 18, wherein the mapping server is configured to adjust the confidence metric based on newly acquired probe data.

20. The system of claim 15, wherein the probe data is lane level map matched.
